(19) United States
(12) Patent Application Publication
(10) Pub. No.: US 2004/0223677 A1
(43) Pub. Date: Nov. 11, 2004

(54) Polymer optical waveguide device using electrooptic effect

(76) Inventors: Sun Tak Park, Taejon (KR); Jung Jin Ju, Taejon (KR); Jung Yun Do, Taejon (KR); Seung Koo Park, Taejon (KR); Myung Hyun Lee, Taejon (KR); Joon Tae Ahn, Taejon (KR); Jong Moo Lee, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/703,530

(22) Filed: Nov. 10, 2003

(30) Foreign Application Priority Data
Apr. 1, 2003 (KR) 2003 - 20460

(51) Int. Cl. G02B 6/10; G02B 6/26

(52) U.S. Cl. 385/1; 385/15

(57) ABSTRACT

The present invention relates to a polymer optical waveguide device using electrooptic effect. A polymer optical waveguide device has Mach-Zehnder interference system structure of dividing a path of a light applied to one optical waveguide into two paths, making the light travel through two optical waveguides, and combining the two optical waveguides into one optical waveguide. A heater is formed on branched one optical waveguide or two optical waveguides. Current is applied to the heater to change the index of refraction of the waveguides so that the bias of the optical device is controlled. The device of the present invention does not affected by the electric characteristic of the polymer but the reliability of the device operation can be improved.

### BACKGROUND OF THE INVENTION

1. Field of the Invention

The present invention relates to optical devices, and more particularly, to optical waveguide devices using electrooptic polymers. By controlling bias of electrooptic polymer waveguide devices by using thermooptic effect, the efficiency and reliability of the devices is improved.

2. Description of the Related Art

Generally, the optical waveguide device consists of a core layer through which light propagates and a clad layer surrounding the core layer, so that the light can be totally reflected and propagate. Such an optical waveguide device is fabricated on various substrates by using thin film fabrication and spin coating. The above-mentioned optical waveguide device is called an optical waveguide device. The materials forming the optical waveguide device widely used are polymer, silica, semiconductor, etc.

Since the optical waveguide device using the polymer is cheap and also can be produced in mass production, the polymeric optical device is being actively studied in various application fields recently.

The polymer optical waveguide devices can be divided into passive polymer and nonlinear polymer devices.

The passive polymer devices using thermooptic effect are applied to optical power splitters and thermooptic switches. The nonlinear polymer devices using the electrooptic effect are used in optical modulators and high-speed switches.

The electrooptic polymer waveguide devices are easily employed in broadband optical modulation and high-speed signal processing behind 100 GHz since the polymers have the low dispersion in the index of refraction between infrared and milimeter-wave frequencies.

The conventional electrooptic waveguide devices are typically biased electrically by applying an appropriate dc voltage but the bias adjustment is very unstable.

In other words, the electrical method is to adjust a bias point by applying voltages to the optical waveguide device consisting of a core layer and a clad layer to change the index of refraction of the portion consisting of an electrooptic material. Due to the electric conductivity difference of materials forming a core layer and a clad layer and the photochemical effect of the electrooptic polymer forming a core layer, the bias point is unstable. Therefore, the device cannot be operated accurately.

To overcome this disadvantage, a method using piezo effect has been suggested but it is very difficult to actually fabricate the device.

### SUMMARY OF THE INVENTION

Accordingly, the present invention is directed to a polymer optical waveguide device using electrooptic effect that substantially obviates one or more problems due to limitations and disadvantages of the related art.

The present invention is directed to solve instability of a bias point of a device due to electrooptic method.

It is an object of the present invention to provide a polymer optical waveguide device using electrooptic effect to stably control a bias operation point of the polymer optical device by using thermooptic effect and changing the index of refraction.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a polymer optical waveguide device of dividing a path of a light applied to one optical waveguide into two paths, making the light travel through two optical waveguides and combining the two optical waveguides into one optical waveguide, comprises: a first optical waveguide including: a substrate, a lower electrode formed on the substrate, a lower clad layer formed on the lower electrode, a core layer for transmitting light formed on the lower clad layer, an upper clad layer formed on the core layer, and an upper electrode formed on the upper clad layer; and a second optical waveguide including: a substrate, a lower clad layer formed on the substrate, a core layer for transmitting light formed on the lower clad layer, an upper clad layer formed on the core layer, and a predetermined number of heaters formed on the upper clad layer, wherein the heaters provided in the second optical waveguide emits heat source and the heat source adjusts bias of the device so that light refraction index is changed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating an electrooptic polymer waveguide device according to embodiment of the present invention;

FIG. 2A is a cross-sectional view illustrating laminating structure of a first optic waveguide of FIG. 1 taken along the line A-A;

FIG. 2B is a cross-sectional view illustrating laminating structure of a second optic waveguide of FIG. 1 taken along the line B-B;

FIG. 3A is a result graph illustrating variation of intensity of an optic output signal when applying electric powers to the heater portion of the second optic waveguide of FIG. 1;

FIG. 3B is a result graph illustrating variation of phase of an optic output signal when applying electricity to the heater portion of the second optic waveguide of FIG. 1;

FIG. 4A is a result graphs illustrating optic output signals when applying voltages to the electrode portion of the first optic waveguide of FIG. 1.

FIGS. 4B, 4C and 4D are result graphs illustrating optic output signals when applying different electric powers to the heater portion of the second optic waveguide of FIG. 1.

### DETAILED DESCRIPTION OF THE INVENTION

Reference will now be made in detail to the preferred embodiments of the present invention, examples of which are illustrated in the accompanying drawings. The present invention disclosed bellow is not limited by the embodiment of the present invention and various modifications and variations can be made in the present invention. The embodiments of the present invention helps the disclosure of the present invention be complete and is provided for those skilled in the art to understand the scope of the present invention.

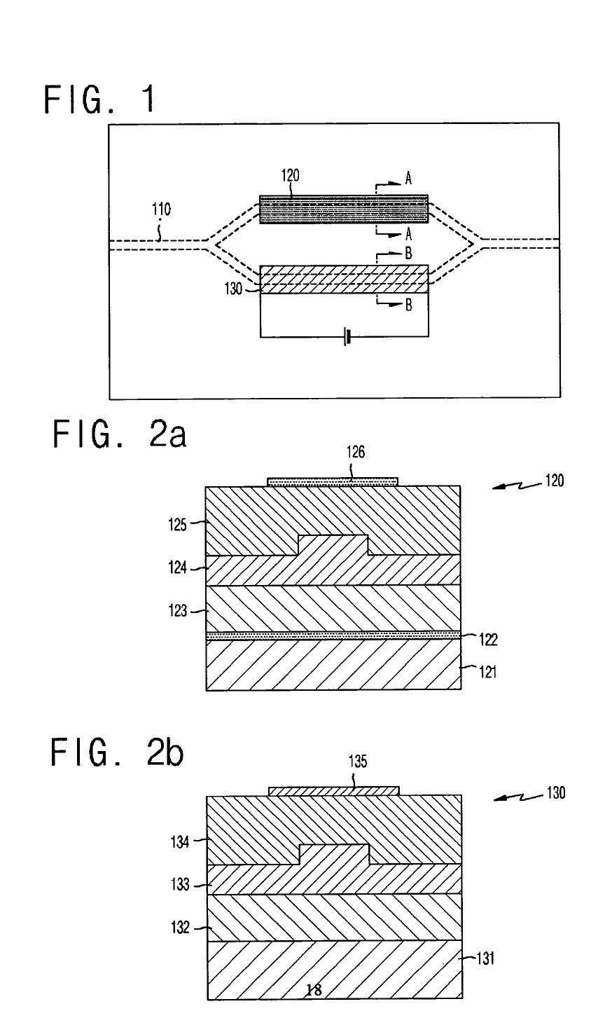

FIG. 1 is a schematic plane view illustrating an electrooptic polymer waveguide device according to embodiment of the present invention.

Referring to FIG. 1, the optic waveguide device of the present invention includes an optic waveguide 110 having Mach-Zehnder interference system structure, a first optic waveguide 120 branched from the optic waveguide 110 and provided with an electrode for electrooptic modulation, and a second optic waveguide 130 provided with a heater for adjusting bias of the device. The split light is combined into one light at the rear of the first optical waveguide 120 and second optical waveguide 130.

In other words, the Mach-Zehnder system splits the incident light into two, makes the split lights travel in different paths and combines the split lights into one light. Therefore, the intensity of the combined light can be modulated by the phase difference between the lights traveling through two paths.

If the phases of the two lights are the same, it becomes ON state in which the intensity of the combined light is the same as those of the two incident lights. If the phase difference between the two lights is 180°, it becomes OFF state in which the combined light diverges so that the traveling lights disappear. In the case of the electrooptic waveguide device, voltage is applied to the branched first optical waveguide 120 and the branched second optical waveguide 130 to make phase difference between the lights that traveled through the two paths so that variation of refraction index is used due to electrooptic effect.

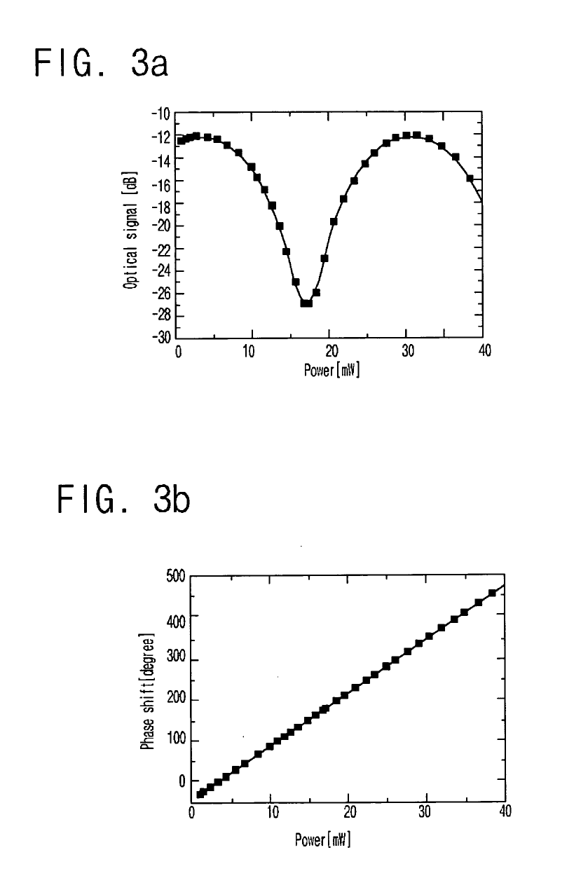

FIG. 2A is a cross-sectional view illustrating laminating structure of a first optic waveguide of FIG. 1 taken along the line A-A. FIG. 2B is a cross-sectional view illustrating laminating structure of a second optic waveguide of FIG. 1 taken along the line B-B.

Referring to FIG. 2A, the first optical waveguide 120 according to the present invention is provided to modulate the phase of a guided light by using electrooptic effect. The first optical waveguide 120 has laminating structure of laminating a lower electrode 122, a lower clad layer 123, a core layer 124, an upper clad layer 125 and an upper electrode 126 on heat absorbing substrate 121 sequentially. Voltage is applied to the upper electrode 126 and the lower electrode 122 to modulate the phase of the guided light.

The heat absorbing substrate 121 can be made of glass substrate, semiconductor substrate or silicon substrate. Preferably, the silicon substrate having high heat conductivity is used as the heat absorbing substrate 121.

The upper electrode 126 and the lower electrode 122 are formed by depositing gold thin film with thickness of 3 μm. The clad layer 125 and the lower clad layer 123 are formed by spin-coating passive polymer. The core layer 124 is formed by spin-coating electrooptic polymer. Here, the same effect can be obtained by using a glass substrate as the lower clad layer 123.

Referring to FIG. 2B, the second optical waveguide 130 according to the present invention is provided to adjust bias of the device. The second optical waveguide 130 has laminating structure of laminating a lower clad layer 132, a core layer 133, an upper clad layer 134 and a heater 135 on a heat absorbing substrate 131 sequentially. The bias of the device is adjusted by applying current to the heater 135 to emit a heat source.

The heat absorbing substrate 131 can be made of glass substrate, semiconductor substrate or silicon substrate. Preferably, the silicon substrate having high heat conductivity is used as the heat absorbing substrate 131.

In the embodiment of the present invention, the structure of laminating the lower clad layer 132 on the heat absorbing substrate 131 is taught but the present invention can omit the substrate 131 as another embodiment. In this case, the lower clad layer 132 can be formed to be so thick as to substitute the substrate 131. A glass substrate can be used as the lower clad layer 132.

The heater 135 laminated on the upper clad layer 134 can be an integrated heater to have a predetermined area or a plurality of hot wires arranged with a predetermined space therebetween.

The heater 135 is formed by depositing material of high heat conductivity such as gold or chromium on the upper clad layer 134 in the form of thin film. The heater is deposited with thickness of about 50-300 nm. Preferably, The heater is deposited with thickness of about 100 nm.

The optical device of the present invention configured as described above branches the guided light applied through the optical waveguide 110 to the first optical waveguide 120 having the upper electrode 126 and the second optical waveguide 130 having the heater 135. The guided light traveling through the first optical waveguide 120 having the upper electrode 126 is phase-modulated by the voltages applied to the upper electrode 126 and the lower electrode 122. The guided light traveling through the second optical waveguide 130 having the heater 135 has the index of refraction reduced by thermooptic effect since the temperature of the polymer surrounding the heater 135 gets higher when current flows through the heater.

The guided lights whose phase difference is modulated are combined into one. The intensity of the combined light depends on phase difference modulation of the split-guided lights traveling the two optical waveguides.

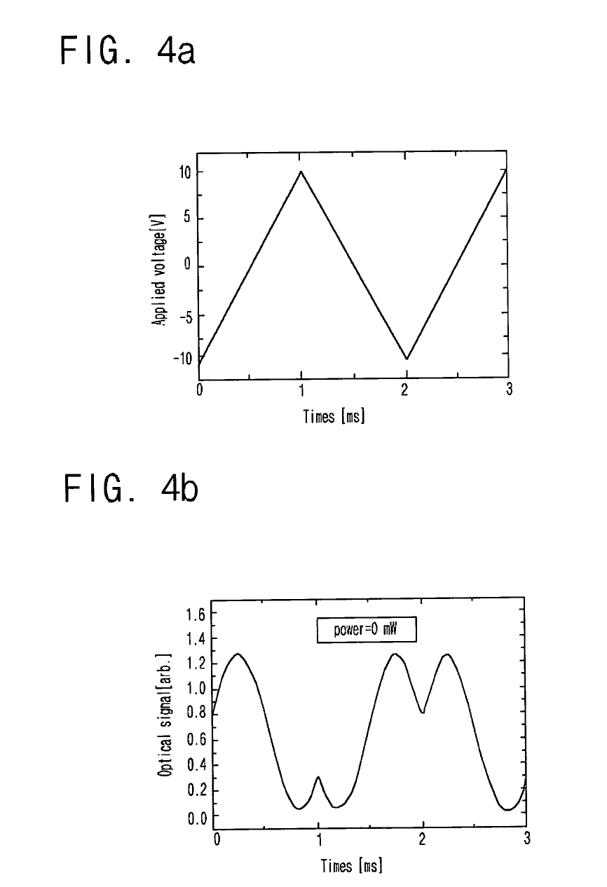

FIG. 3A is a result graph illustrating measured intensity of an optic output signal when applying electric powers to the heater 135 of the second optic waveguide of the electrooptic polymer waveguide.

Referring to the graph of FIG. 3A, in the present invention, the intensity of the output signal is maximum when the electric power applied to the heater 135 of the second optical waveguide is 3.2 mW and the intensity of the output signal is minimum when the electric power applied to the heater 135 of the second optical waveguide is 17.2 mW.

From the result of measurement as shown in FIG. 3A, it is found that the present invention can change the phase of 180° on one arm of the Mach-Zehnder system with only small electric power of 14 mW. This is possible since the thermooptic coefficient of the polymer is very large as about −1×10⁻⁴/° C.

FIG. 3B is a result graph illustrating variation of phase of an optic output signal of FIG. 3B and particularly, the graph illustrating measured phase difference of the guided lights each traveling through the branched different optical waveguide according to the applied electric power. According to the above-mentioned graph, it is found that the phase of the guided light increases proportional to the applied electric power.

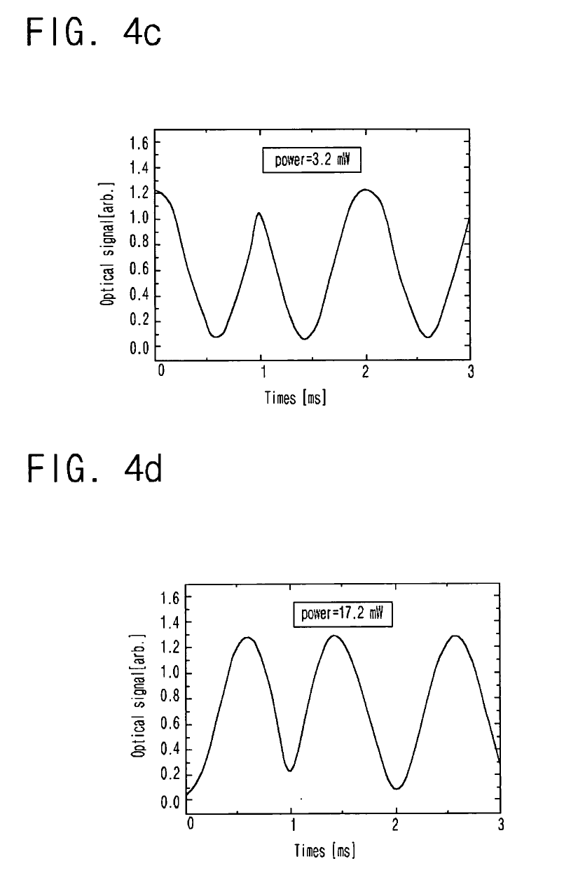

FIGS. 4A, 4B, 4C and 4D are result graphs illustrating bias point variation when applying electric powers to heater re portion for adjusting bias of the electrooptic polymer optical waveguide device shown in FIG. 1.

FIG. 4A is a graph illustrating relation between driving voltage applied to the upper electrode and frequency modulation. Referring to FIG. 4A, the driving voltage applied to the upper electrode 126 is modulated with 500 Hz between −10 V and 10 V.

FIG. 4B is a graph illustrating intensity of the optical output signal when electric power is not applied to the heater but only the driving voltage is modified.

FIG. 4C is a graph illustrating intensity of the optical output signal according to the driving voltage when electric power of 3.2 mW is applied to the heater. The device of the present invention outputs maximum optical output signal when the driving voltage is 10 V.

FIG. 4D is a graph illustrating intensity of the optical output signal according to the driving voltage when electric power of 17.2 mW is applied to the heater. The device of the present invention outputs minimum optical output signal when the driving voltage is 10 V. According to such a result, it is found the device of the present invention can control the operation point of the device with small electric power of only 14 mW.

The electooptic polymer optical device of the present invention described above is provided with a heater to adjust bias of the device. The reliability and efficiency of the device can be improved by applying the driving voltage to the heater so as to use thermooptic effect since the device of the present invention does not affected by the electric characteristic of the polymer.

The above description was made merely as embodiments to teach the polymer optical waveguide device using electrooptic effect according to the present invention. The present invention is not limited to the embodiments and it will be apparent to those skilled in the art that various modifications and variations can be made in the present invention. Thus, it is intended that the present invention covers the modifications and variations of this invention provided they come within the scope of the appended claims and their equivalents.

1. A polymer optical waveguide device of dividing a path of a light applied to one optical waveguide into two paths, making the light travel through two optical waveguides and combining the two optical waveguides into one optical waveguide, comprising:
a first optical waveguide including: a substrate, a lower electrode formed on the substrate, a lower clad layer formed on the lower electrode, a core layer for transmitting light formed on the lower clad layer, an upper clad layer formed on the core layer, and an upper electrode formed on the upper clad layer; and
a second optical waveguide including: a substrate, a lower clad layer formed on the substrate, a core layer for transmitting light formed on the lower clad layer, an upper clad layer formed on the core layer, and a predetermined number of heaters formed on the upper clad layer,
wherein the heater provided in the second optical waveguide emits heat source and the heat source adjusts bias of the device so that light refraction index is changed.

2. The polymer optical waveguide device of claim 1, wherein the lower clad layer and the upper clad layer are made of polymer.

3. The polymer optical waveguide device of claim 1, wherein the core layer is an electrooptic polymer.

4. The polymer optical waveguide device of claim 1, wherein the upper clad layer has the one heater or the two heaters arranged thereon.

5. The polymer optical waveguide device of claim 1, wherein the heater is made of any one selected from the group consisting of gold and chromium.

6. The polymer optical waveguide device of claim 1, wherein the heater is formed on the upper clad layer in the form of thin film by using vapor deposit method.

7. The polymer optical waveguide device of claim 1, wherein the index of refraction of an optical waveguide formed on any one of the first and second optical waveguides is changed by using thermooptic effect.

8. The polymer optical waveguide device of claim 4, wherein the heater is formed on the upper clad layer in the form of thin film by using vapor deposit method.

9. The polymer optical waveguide device of claim 5, wherein the heater is formed on the upper clad layer in the form of thin film by using vapor deposit method.
